(19) United States
(12) Patent Application Publication
(10) Pub. No.: US 2008/0143742 A1
(43) Pub. Date: Jun. 19, 2008

(54) METHOD AND APPARATUS FOR EDITING IMAGE, GENERATING EDITING IMAGE, AND STORING EDITED IMAGE IN PORTABLE DISPLAY DEVICE

(75) Inventors: Ji-won Jeong, Suwon-si (KR); Cheol-ho Jeong, Suwon-si (KR); Seong-hun Jeong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/958,931

(22) Filed: Dec. 18, 2007

(30) Foreign Application Priority Data
Dec. 18, 2006 (KR) 10-2006-0129660

(51) Int. Cl. G09G 5/00

(52) U.S. Cl. 345/619

(57) ABSTRACT

An image editing method of inputting a vector graphic component and editing and utilizing an original image in various forms in a portable display device is provided. The method includes inputting an original image to be edited, inputting a vector graphic component to be added to the original image, and editing the vector graphic component together with the original image. Accordingly, an image can be conveniently edited, even when using limited hardware, such as the portable display device.

### CROSS-REFERENCE TO RELATED PATENT APPLICATION

This application claims priority from Korean Patent Application No. 10-2006-0129660, filed on Dec. 18, 2006 in the Korean Intellectual Property Office, the disclosure of which is incorporated herein in its entirety by reference.

### BACKGROUND OF THE INVENTION

1. Field of the Invention

Apparatuses and methods consistent with the present invention relate to image editing, and more particularly, to editing and utilizing an original image in various forms by inputting a graphic component to a portable display device having a display unit.

2. Description of the Related Art

Recently, most people capture and store photographs or moving pictures using a digital camera, a camcorder, or a portable terminal having a camera function. Most people also use the captured images for various purposes, such as for a background image of a personal computer (PC) or portable terminal, uploading them to a personal homepage, or creating an electronic photo album. The variety of different uses of captured images demands new methods of granting a special meaning to a captured image in addition to capturing the image. Thus, various methods have been provided for using a captured image in a new form by editing and processing the captured image based on a user's desire.

Images can be edited and processed by applying various transforms, such as scaling, rotating, skewing, and distortion; by applying color compensation filters, such as contrast, brightness, black and white, sepia, and negative; by inserting symbols or words; and by synthesizing several images.

When an image in a portable display device is edited, two methods are generally used: the first is to move the image to a PC having a commercial graphics tool and edit the image in the PC; and the second is to edit the image using a simple editing function in the portable display device.

When the first method is used, it is troublesome to have to move the image to the PC, and commercial graphics tools, such as Photoshop, and Paint Shop, are complex and difficult for the average user.

When the second method is used, although the image does not need to be moved to a PC, editing is difficult due to the limited hardware of the portable display device, which has a small screen and an insufficient interface. It is also difficult to achieve the desired editing, since the editing function is usually limited to superimposing predefined graphics on the image.

FIG. 1 illustrates an image editing operation in a related art portable display device.

FIG. 1 shows an image 110 to be edited, which is stored in the portable display device, alongside an edited image 120 edited by an editing operation of a user. Image editing capability provided by related art portable display devices, such as digital cameras, portable terminals, MP3 players, and Portable Multimedia Players (PMPs), usually allows only the following simple operations due to hardware limitations, such as the small sized screen and the limited interface:

(1) insert predefined symbols, words, and emoticons;

(2) modify the brightness and contrast of the entire image;

(3) input custom words through a keypad; and

(4) add an entire background image or layer to an image.

Editing components are synthesized with the original image 110, and the resulting edited image 120 is stored as a file. That is, the edited components are superimposed on the original image 110.

Since the screen size and resolution of most portable display devices having the editing function is at most Quarter Video Graphics Array (QVGA) level (320×240), it is difficult to perform the desired editing on the small screen.

When an image is edited and stored in a portable display device, since the edited image is obtained by superimposing edited components on original image and stored as a file, editing components, such as symbols, words, and emoticons, which are frequently used by a user, cannot be reused.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and an apparatus for easily editing an image and storing an edited image using vector graphics in a portable display device.

According to an aspect of the present invention, there is provided an image editing method for a portable display device, the method including: inputting an original image to be edited; inputting a vector graphic component to be added to the original image; and editing the vector graphic component together with the original image.

The vector graphic component to be edited may include relative position information and size information with respect to the resolution of the original image or a screen of the portable display device.

The inputting of the vector graphic component may include inputting at least one of an edited and stored vector graphic component, a vector graphic component provided from the outside, and a vector graphic component generated by a user input.

The inputting of the vector graphic component may be performed in an input window which provides a magnified display.

A plurality of vector graphic components to be edited may be able to be individually accessed on the original image.

The vector graphic components to be edited may be displayed on a screen with the original image.

The vector graphic components may be displayed in real time during the editing.

According to another aspect of the present invention, there is provided an image editing method for a portable display device, the method including: inputting an original image to be edited; inputting a separate file including a vector graphic component to be added to the original image; extracting the vector graphic component from the file; and editing the vector graphic component together with the original image.

The separate file including the vector graphic component may be a file including an edited and stored vector graphic component or a vector graphic component edited and stored with the original image.

The extracting may include extracting the plurality of vector graphic components individually or as a group, if a plurality of vector graphic components are included in the separate file.

The plurality of vector graphic components to be edited may be individually accessed on the original image.

The vector graphic components to be edited may be displayed in real time on a screen with the original image.

According to another aspect of the present invention, there is provided an editing image generating method for a portable display device, the method including: providing an input window for generating an editing image; inputting the editing image in a vector graphic format by means of the input window; and transforming the editing image to a form for display.

The vector graphic format may include relative position information and size information on a screen for display.

The input window for generating the editing image may provide a magnified display.

If a plurality of editing images in the vector graphic format are input, the transforming may include individually transforming the plurality of editing images.

The method may further include storing the transformed editing image, wherein if a plurality of editing images are stored, the plurality of editing images are stored to be individually accessed.

According to another aspect of the present invention, there is provided an edited image storing method for a portable display device, the method including: determining whether an image editing operation has ended; if it is determined that the image editing operation has ended, determining whether a vector graphic component is included in an edited image; and storing the vector graphic component based on the determination result.

The method may further include determining whether the vector graphic component is stored as a separate file, if it is determined that a vector graphic component is included in the edited image.

The method may further include extracting the vector graphic component from the edited image; and storing the vector graphic component as a separate file from the edited image, if it is determined that the vector graphic component is stored as a separate file.

The method may further include storing the vector graphic component with the edited image as the same file if it is determined that the vector graphic component is not stored as a separate file.

If it is determined that a plurality of vector graphic components are included in the edited image, the storing may include storing the plurality of vector graphic components to be individually accessible.

The storing may include storing the resolution of an original image of the edited image and position information and size information of the vector graphic component.

The position information and size information may be a ratio of the vector graphic component with respect to the resolution of the original image or a screen of the portable display device.

According to another aspect of the present invention, there is provided an image editing apparatus having a portable display unit, the apparatus including an input unit for inputting an original image to be edited and inputting a vector graphic component to be added to the original image; an editing processing unit which edits the vector graphic component together with the original image; and an output unit which displays the edited original image and vector graphic component.

The input unit may further include a generator which generates a vector graphic component to be added to the original image.

The input unit may further include an extractor which extracts the vector graphic component to be added to the original image from a file input by means of the input unit.

If a plurality of vector graphic components are included in the input file, the extractor may extract the plurality of vector graphic components individually or as a group.

The plurality of vector graphic components edited by the editing processing unit may be individually accessed on the original image.

The vector graphic component edited by the editing processing unit may include relative position information and size information with respect to the resolution of the original image or a screen of the portable display device.

The output unit may display the vector graphic component edited by the editing processing unit in real time on a screen together with the original image.

According to another aspect of the present invention, there is provided an edited image storing apparatus in a portable display device, the apparatus including a determiner which determines whether a vector graphic component is included in an edited image, if an image editing operation has ended; and a storage unit which stores the vector graphic component based on a result determined by the determiner.

The storage unit may further include a selector, which determines whether the vector graphic component is stored as a separate file, if it is determined by the determiner that a vector graphic component is included in the edited image.

The storage unit may further include an extractor, which extracts the vector graphic component from the edited image, if it is determined by the selector that the vector graphic component is stored as a separate file.

The storage unit may store the vector graphic component as a separate file from the edited image if it is determined by the selector that the vector graphic component is stored as a separate file, or store the vector graphic component with the edited image as the same file if it is determined by the selector that the vector graphic component is not stored as a separate file.

If it is determined by the determiner that a plurality of vector graphic components are included in the edited image, the storage unit may store the plurality of vector graphic components to be individually accessible.

The storage unit may store the resolution of an original image of the edited image and position information and size information of the vector graphic component.

The position information and size information may be a ratio of the vector graphic component with respect to the resolution of the original image or a screen of the portable display device.

According to another aspect of the present invention, there is provided a computer readable recording medium which stores a computer readable program for executing the image editing method, the editing image generating method, and the edited image storing method in a portable display device.

### BRIEF DESCRIPTION OF THE DRAWINGS

The above and other aspects of the present invention will become more apparent by describing in detail exemplary embodiments thereof with reference to the attached drawings in which:

FIG. 1 illustrates an image editing operation in a related art portable display device;

FIG. 2 is a flowchart of an image editing method in a portable display device according to an exemplary embodiment of the present invention;

FIG. 3 illustrates an image editing operation in a portable display device according to an exemplary embodiment of the present invention;

FIG. 4 is a flowchart of an image editing method in a portable display device according to another exemplary embodiment of the present invention;

FIG. 5 is a flowchart of an editing image generating method in a portable display device according to another exemplary embodiment of the present invention;

FIG. 6 is a flowchart of an edited image storing method in a portable display device according to another exemplary embodiment of the present invention;

FIG. 7 is a diagram describing the resolution of an original image and the relative position and size ratio of a vector graphic component in a process of storing an edited image in a portable display device according to another exemplary embodiment of the present invention;

FIG. 8 is a block diagram of an image editing apparatus having a portable display unit according to another exemplary embodiment of the present invention; and

FIG. 9 is a block diagram of an edited image storing apparatus in a portable display device according to another exemplary embodiment of the present invention.

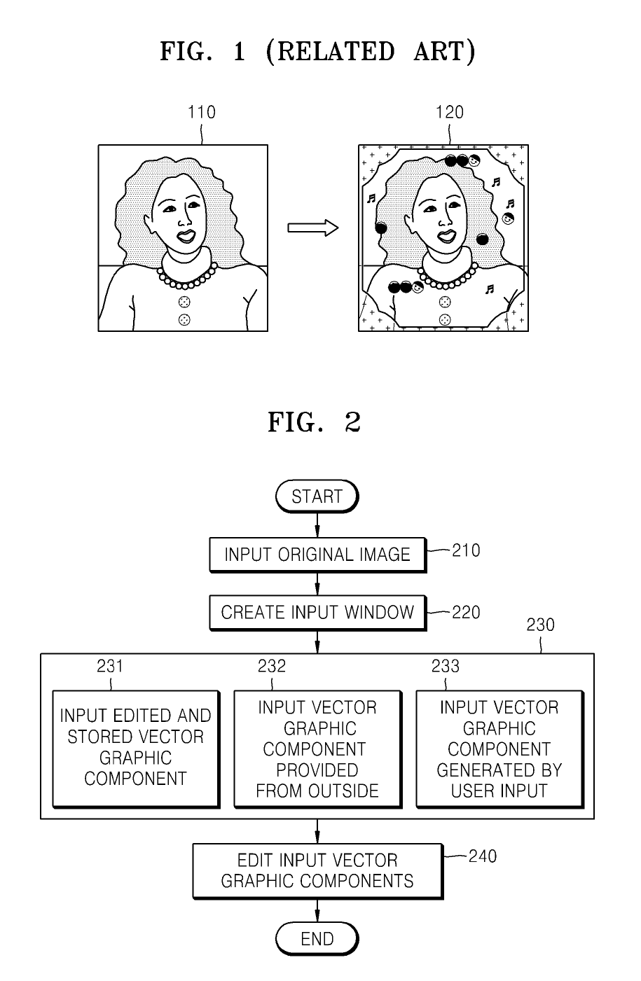

### DETAILED DESCRIPTION OF EXEMPLARY EMBODIMENTS OF THE INVENTION

The present invention will now be described in detail by explaining exemplary embodiments of the invention with reference to the attached drawings.

FIG. 2 is a flowchart of an image editing method in a portable display device according to an exemplary embodiment of the present invention.

Referring to FIG. 2, an original image is input in operation 210. The original image may be a photograph stored in the portable display device, or an image newly captured using a digital camera function, for example.

An input window is created in operation 220. This operation provides an interface to input a vector graphic component to be added to the original image.

The vector graphic component is represented by rendering an image using lines and curves expressed by vectors including color and position information. The vector graphic component creates a final digital image by means of a series of commands or mathematical expressions describing lines or figures arranged in a two-dimensional or three-dimensional space, and thus has the advantage of being independent of resolution. That is, while maintaining the shape and quality of an image rendered as a vector graphic component, movement, size adjustment, shape change, and color change of the vector graphic component can be performed, and the vector graphic component can be displayed by display devices having various resolutions. The vector graphic component is stored as a graphics file in the form of a series of vector descriptions. For example, in order to draw a line, the vector graphic component includes the positions of a series of dots instead of storing bits. Thus, the file size is decreased.

Compared to the vector graphic component, a bitmap graphic component is constituted of dots called pixels arranged in a grid. When the bitmap graphic component is edited, its pixels are modified, instead of lines or curves. The bitmap graphic component influences resolution, since data representing an image is fixed in a grid. Thus, if the bitmap graphic component is magnified, its edges become stepped, because the pixels are rearranged in the grid. Also, the bitmap graphic component needs more data bytes for storage.

The vector graphic component is input by means of the input window created in operation 220 using the features of the vector graphic component. In this case, in order to minimize inconvenience of the limited resolution of the portable display device, an input operation can be performed by means of the input window providing a magnified display. Thus, an editing image is input in a vector graphic format using the entire screen, regardless of its actual position to be arranged with respect to the original image. The size and position of the editing image on the original image is finally adjusted in an editing operation, in operation 240.

The vector graphic component input by means of the input window is classified into one of three cases in operation 230. The first case is an edited and stored vector graphic component 231. This is a vector graphic component stored as a separate file by means of an edited image storing method according to an exemplary embodiment of the present invention, which will be described later. The second case is a vector graphic component 232 provided from the outside. This is a file in a vector graphic format provided from an external source via various input/output interfaces and networks. The third case is a vector graphic component 233 generated by means of a user input. This is an image produced by a user using the portable display device, and is input in a vector graphic format by means of the input window using the entire screen.

The input vector graphic components are edited in operation 240. That is, the input vector graphic components are modified to a desired shape. Since the input vector graphic components are used to edit the original image, the user reprocesses the input vector graphic components to be added based on the original image. For example, a final editing result is derived through various processing operations, such as size adjustment, position movement, gradient adjustment, rotation, distortion effects, contrast, and color compensation of the input vector graphic components.

The vector graphic components that are to be edited can be accessed individually. That is, the vector graphic components can be adjusted independently of the original image, and selected and adjusted independently of each other. This means that each vector graphic component has object-oriented information.

Since the positions, sizes, and directions of the vector graphic components must be adjusted based on the original image in the editing operation, the vector graphic components are displayed together with the original image. In addition, the vector graphic components may be displayed in real-time during the editing operation.

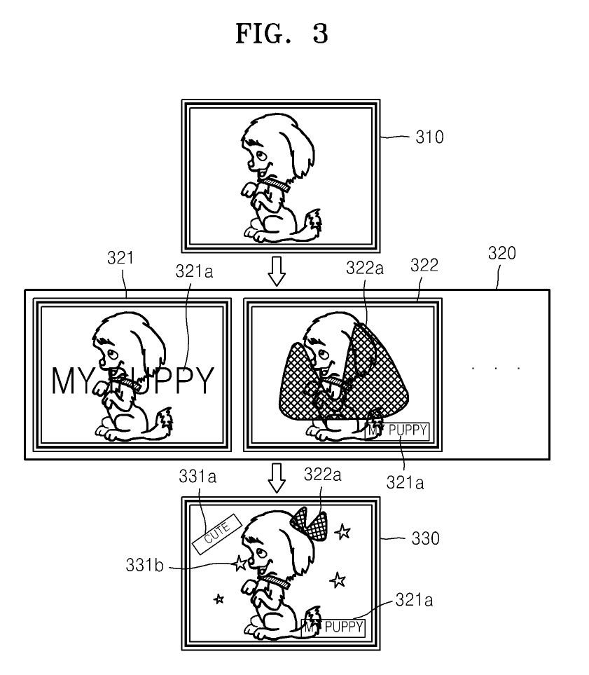

FIG. 3 illustrates an image editing operation in a portable display device according to an exemplary embodiment of the present invention.

Referring to FIG. 3, the editing operation according to an exemplary embodiment of the present invention will now be described. It is assumed that an original image 310 is a picture of a puppy, and a series of vector graphic components are input in operation 320 to edit the original image 310. Referring to the final edited image 330, although inserted words “my puppy” 321a are located at the right bottom corner in small letters in the final edited image 330, the words “my puppy” 321a are input using the entire screen 321 in operation 320, regardless of the final edited image 330. In addition, a precise shape of image 322a can be input directly. If a user had directly input a small image on the original image 310 from the image input operation, the operation would require very minute drawing. Thus, by making maximum use of the small screen, the precise shape of image 322a can be input on the entire screen 322. As described above, an edited and stored vector graphic component and/or a vector graphic component provided from the outside can be input in the same manner.

Since the editing images input in operation 320 are generated in a vector graphic format, size adjustment, position movement, and the like can be performed on the editing images while maintaining the same shape and quality without any influence on resolution, as well as the features of the vector graphic component described above. According to the final edited image 330, the words “my puppy” 321a, the image 322a, other words 331a, another image 331b, and other elements are shown with adjusted size and position based on the original image 310.

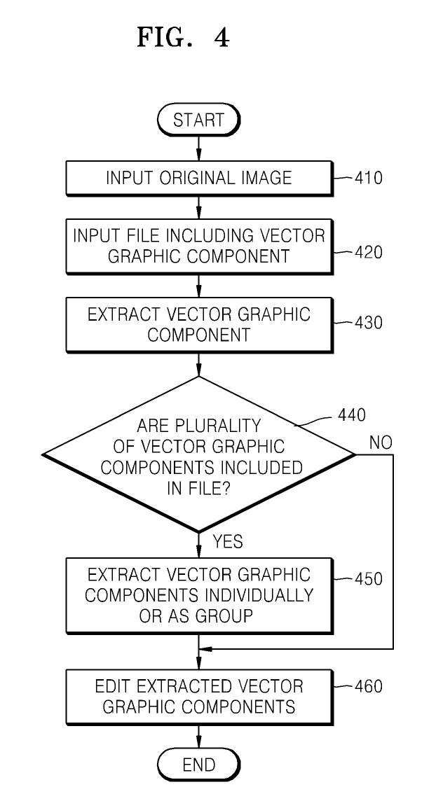

FIG. 4 is a flowchart of an image editing method in a portable display device according to another exemplary embodiment of the present invention.

Referring to FIG. 4, an original image to be edited is input in operation 410.

A separate file including a vector graphic component that is to be added to the original image is input in operation 420. The separate file includes an edited and stored vector graphic component, or a vector graphic component which was edited and stored with an original image. As will be described later, for an edited image which is stored according to an exemplary embodiment of the present invention, only a vector graphic component can be stored as a separate file or stored with an original image. Thus, if it is needed to reuse edited images, the stored file will be a new input.

In order to reuse the vector graphic component included in the separate file, the vector graphic component is extracted in operation 430. Since a plurality of vector graphic components may be included in the separate file, it is determined in operation 440 whether a plurality of vector graphic components are included in the separate file. If it is determined in operation 440 that a plurality of vector graphic components are included in the separate file, the plurality of vector graphic components can be extracted individually or as a group in operation 450.

The extracted vector graphic components are edited with the original image in operation 460. When the plurality of vector graphic components are individually extracted from the input file, the user can obtain their desired result by processing such as magnification, reduction, position adjustment, rotation, and the like, of the extracted vector graphic components, based on the original image.

When the plurality of vector graphic components are extracted as a group from the input file, since a plurality of vector graphic components in a single group operate as if they were a single component, the plurality of vector graphic components in the same group are edited in size and position together.

In addition, in operation 460, since the positions, sizes, and directions of the plurality of vector graphic components must be adjusted based on the original image, the plurality of vector graphic components may be displayed in real time together with the original image.

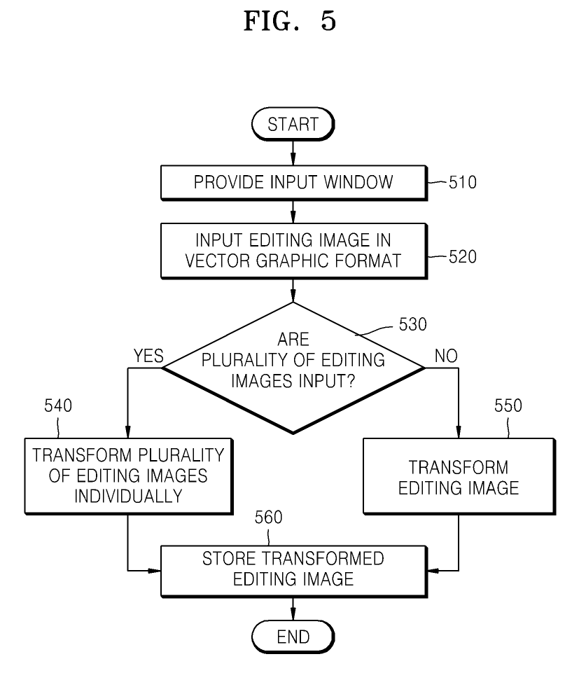

FIG. 5 is a flowchart of an editing image generating method in a portable display device according to another exemplary embodiment of the present invention.

Referring to FIG. 5, the editing image generating method includes providing an input window for generating an editing image (referred to as 510), inputting the editing image in a vector graphic format by means of the input window (referred to as 520), and transforming the editing image to a form for display (referred to as 540 and 550).

The editing image is input by a user, who directly inputs a vector graphic component to the input window provided by the portable display device via an input interface. In order to support a smooth input operation on a small screen, the input window can provide a magnified display. Thus, the user can input the editing image in the vector graphic format using the entire screen, regardless of the position of the editing image in the original image.

If it is determined in operation 530 that a plurality of editing images are input in the vector graphic format, then when the plurality of editing images are transformed to the form for display, the plurality of editing images can be individually transformed in operation 540. The transform operation is an operation to transform the editing images to an eXtensible Markup Language (XML) type, in order to display and use the editing images in the vector graphic format in an image editing operation in the future.

The editing image generating method can further include storing the transformed editing image (referred to as 560). If the plurality of editing images are stored, the plurality of editing images are stored to be individually accessible.

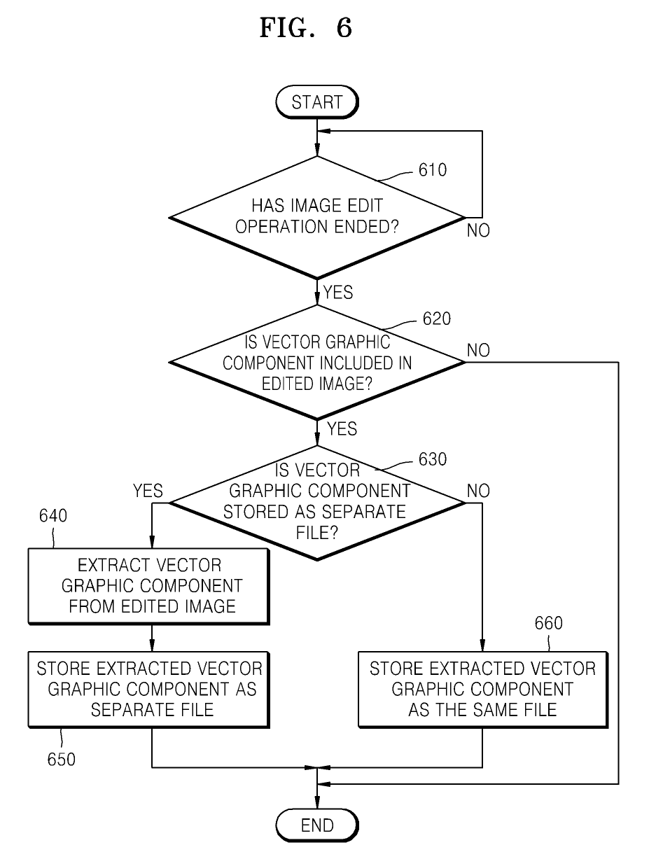

FIG. 6 is a flowchart of an edited image storing method in a portable display device according to another exemplary embodiment of the present invention.

Referring to FIG. 6, after it is determined in operation 610 whether an image editing operation has ended, and before the final edited image is stored, it is determined in operation 620 whether a vector graphic component is included in the edited image. If it is determined in operation 620 that a vector graphic component is included in the edited image, it is determined in operation 630 whether the vector graphic component is stored separately from the original image. Based on the determination result in operation 630, the vector graphic component may be stored as a separate file, or stored with the original image as the same file. If it is determined in operation 630 that the vector graphic component is stored as a separate file, the vector graphic component must be separate from the edited image, and the vector graphic component can be extracted independently of the original image, due to the object-oriented attribute of vector graphic components, in operation 640. The extracted vector graphic component is stored as a separate file in operation 650. By classifying and storing the vector graphic component for reuse, the vector graphic component can be easily reused as an edited and stored vector graphic component in a future editing operation. If it is determined in operation 630 that the vector graphic component is stored with the original image as the same file, the vector graphic component is stored by being synthesized with the original image as the same file in operation 660. In this case, as illustrated in FIG. 4, the vector graphic component can be reused as a file including the vector graphic component stored with the original image.

In operations 650 and 660, the resolution of the original image and position information and size information of the vector graphic component (editing graphic component) are stored together, and the contents stored may be:

1. vector graphic data: the editing graphic component generated by user input;

2. the resolution of the original image;

3. the start position of the editing graphic component based on the original image;

4. the size of the editing graphic component based on the original image;

5. the start position of the editing graphic component based on the screen resolution;

6. the size of the editing graphic component based on the screen resolution; and

7. a rotation value of the editing graphic component.

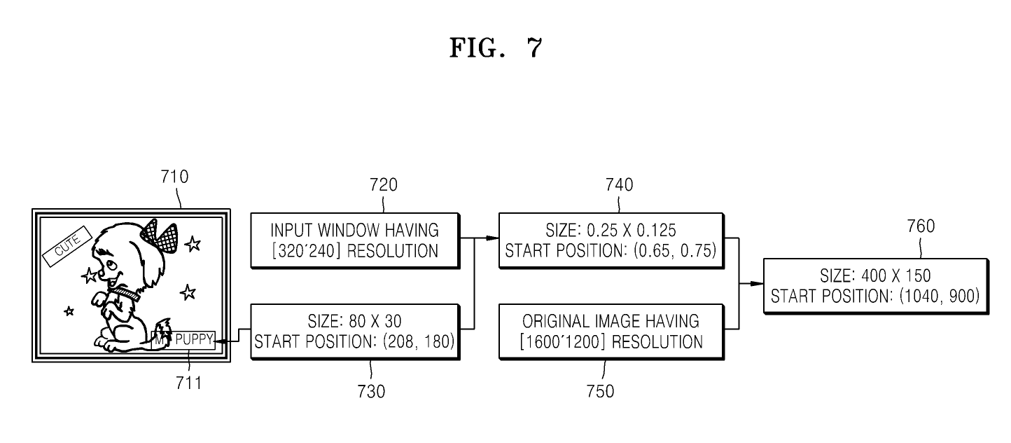

Here, the start position and the size of the vector graphic component can be a relative ratio based on the original image or the screen resolution. In addition, the start position and the size with respect to the resolution of the original image and the screen resolution can be calculated from each other using resolution information of the original image. This will be described in detail with reference to FIG. 7.

FIG. 7 is a diagram describing the resolution of an original image and the relative position and size ratio of a vector graphic component in a process of storing an edited image in a portable display device according to another exemplary embodiment of the present invention.

Referring to FIG. 7, inserted words “my puppy” 711 located at the bottom right corner of a final edited image 710 will now be described as an example.

The portable display device provides an edit window (input window) 720 having a resolution of 320×240. On a screen having the resolution of 320×240, the size of the inserted words “my puppy” 711 is 80×30, and the start position is (208, 180) (referred to as 730). When the size and the start position are transformed to a relative size and a relative start position, i.e. relative ratios with respect to the screen resolution, the relative size is (80/320×30/240)=0.25×0.125, and the relative start position is (208/320, 180/240)=(0.65, 0.75) (referred to as 740). Thus, using the relative ratios, when a user wants to output the edited image 710 by means of a device such as a personal computer (PC) having a different resolution in the future, the image can be adjusted to fit the resolution of the device. The resolution of the original image is 1600×1200, and if the edited image 710 is output to fit the resolution of the original image, the size and start position of the inserted words “my puppy” 711 are 400×150 and (1400, 900), respectively. This operation is performed to synchronize the resolution of the original image with the screen resolution of the portable display device, since the resolution of the original image and the screen resolution of the portable display device are different. That is, the relative position and size of a vector graphic component are calculated based on current screen resolution. The relative position and size of the vector graphic component are stored, and when the vector graphic component is processed in the future, the stored information is calculated again to fit the resolution of an original image of interest.

Since the user believes that an image that is edited using the small screen of the portable display device can be viewed later on another device having a large screen, it is important to fulfill the user's expectation. Since vector graphic components are not influenced by movement or size change while maintaining their shape and quality, an editing image stored in the vector graphic format can maintain the same shape and arrangement in a different resolution, as illustrated in FIG. 7.

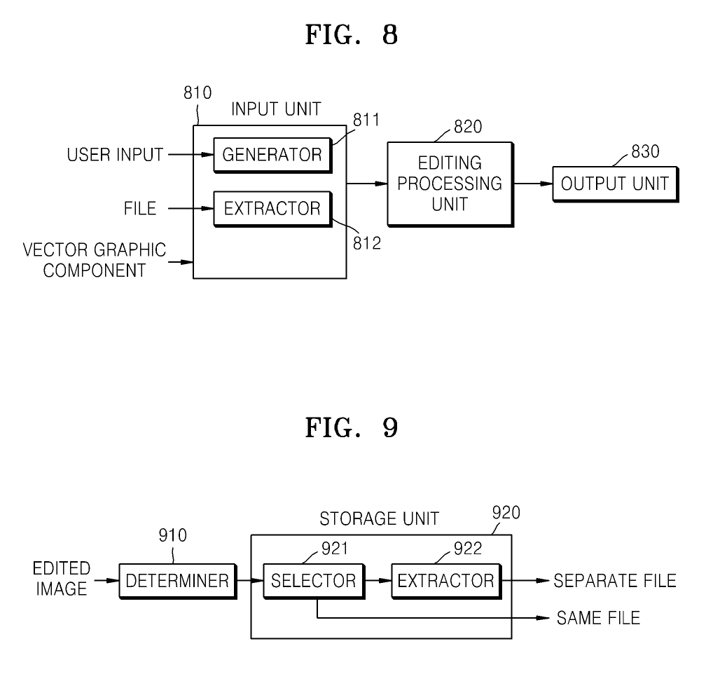

FIG. 8 is a block diagram of an image editing apparatus having a portable display unit according to another exemplary embodiment of the present invention.

Referring to FIG. 8, an input unit 810 inputs an original image to be edited and inputs a vector graphic component to be added to the original image. In order to accommodate the case where a user desires to directly generate a vector graphic component by means of a user input, the input unit 810 can further include a generator 811 for generating the vector graphic component. In order to accommodate the case where a file including a vector graphic component is input, the input unit 810 can further include an extractor 812 for extracting the vector graphic component from the file.

An editing processing unit 820 edits the input vector graphic components together with the original image. That is, the editing processing unit 820 executes an edit operation based on the user's desire with the various vector graphic components and the original image. An output unit 830 displays the original image, and vector graphic components edited by the editing processing unit 820 on a screen in real-time.

FIG. 9 is a block diagram of an edited image storing apparatus in a portable display device according to another exemplary embodiment of the present invention.

Referring to FIG. 9, the edited image storing apparatus includes a determiner 910, which determines whether a vector graphic component is included in an edited image if an image editing operation has ended, and a storage unit 920 which stores the vector graphic component based on the result determined by the determiner 910.

The storage unit 920 can further include a selector 921, which determines whether the vector graphic component is stored as a separate file, if it is determined by the determiner 910 that a vector graphic component is included in the edited image.

The storage unit 920 can further include an extractor 922, which extracts the vector graphic component from the edited image, if it is determined by the selector 921 that the vector graphic component is stored as a separate file.

The storage unit 920 stores the vector graphic component extracted by the extractor 922 as a separate file from the edited image if it is determined by the selector 921 that the vector graphic component is stored as a separate file. The storage unit 920 stores the vector graphic component with the edited image as the same file if it is determined by the selector 921 that the vector graphic component is not stored as a separate file.

The image editing method, the editing image generating method, and the edited image storing method according to exemplary embodiments of the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

As described above, according to the image editing method, the editing image generating method, and the edited image storing method according to exemplary embodiments of the present invention, an image can be conveniently edited and stored even using limited hardware such as a portable display device.

By generating vector graphic components based on the contents input by the user by means of the portable display device, and editing using the vector graphic components, the user can freely edit an image to a desired form. Thus, modifications such as size adjustment and rotation are performed using the advantages of vector graphics, so that image deterioration does not occur, and the user can conveniently edit the image even using limited hardware with a small screen and an insufficient interface.

In addition, since editing contents can be created as a separate file, the user can edit a single original image in various manners and reuse stored editing contents.

While this invention has been particularly shown and described with reference to exemplary embodiments thereof, it will be understood by those skilled in the art that various changes in form and detail may be made therein without departing from the spirit and scope of the invention as defined by the appended claims and their legal equivalents. The exemplary embodiments should be considered in a descriptive sense only, and not for purposes of limitation. Therefore, the scope of the invention is defined not by the detailed description of the invention but by the appended claims, and all differences within the scope will be construed as being included in the present invention.

What is claimed is:

1. An image editing method for a portable display device, the method comprising:
inputting an original image to be edited;
inputting a vector graphic component to be added to the original image; and
editing the vector graphic component together with the original image.

2. The method of claim 1, wherein the vector graphic component to be edited comprises relative position information and size information with respect to a resolution of the original image or a screen of the portable display device.

3. The method of claim 2, wherein the inputting the vector graphic component comprises inputting at least one of an edited and stored vector graphic component, a vector graphic component provided from outside, and a vector graphic component generated by a user input.

4. The method of claim 3, wherein the inputting of the vector graphic component is performed in an input window which provides a magnified display.

5. The method of claim 2, wherein the vector graphic component to be edited can be individually accessed on the original image.

6. The method of claim 5, wherein the vector graphic component to be edited is displayed on a screen with the original image in real time during the editing.

7. An image editing method for a portable display device, the method comprising:
inputting an original image to be edited;
inputting a separate file comprising a vector graphic component to be added to the original image;
extracting the vector graphic component from the file; and
editing the vector graphic component together with the original image.

8. The method of claim 7, wherein the separate file comprises at least one of an edited vector graphic component and a vector graphic component edited and stored with the original image.

9. The method of claim 8, wherein the extracting comprises extracting a plurality of vector graphic components individually or as a group, if the separate file further comprises the plurality of vector graphic components.

10. An edited image storing method for a portable display device, the method comprising:
confirming whether an image editing operation has ended;
determining whether an edited image comprises a vector graphic component if it is confirmed that the image editing operation has ended; and
storing the vector graphic component based on the determination result.

11. The method of claim 10, further comprising selecting whether the vector graphic component is stored as a separate file if it is determined that the edited image comprises the vector graphic component.

12. The method of claim 11, further comprising:
extracting the vector graphic component from the edited image and storing the vector graphic component as a separate file from the edited image if it is selected that the vector graphic component is stored as a separate file; or
storing the vector graphic component with the edited image as the same file if it is selected that the vector graphic component is not stored as a separate file.

13. The method of claim 10, wherein the storing comprises storing a plurality of vector graphic components to be individually accessible if it is determined that the edited image comprises the plurality of vector graphic components.

14. The method of claim 13, wherein the storing further comprises storing a resolution of an original image of the edited image and position information and size information of the vector graphic component.

15. An image editing apparatus having a portable display unit, the apparatus comprising:
an input unit which inputs an original image to be edited and a vector graphic component to be added to the original image;
an editing processing unit which edits the vector graphic component together with the original image; and
an output unit which displays the edited original image and the edited vector graphic component.

16. The apparatus of claim 15, wherein the input unit further comprises a generator which generates a vector graphic component to be added to the original image.

17. The apparatus of claim 15, wherein the input unit further comprises an extractor which extracts the vector graphic component to be added to the original image from a file input by means of the input unit, wherein if the input file comprises a plurality of vector graphic components, the extractor extracts the plurality of vector graphic components individually or as a group.

18. The apparatus of claim 15, wherein a plurality of vector graphic components edited by the editing processing unit can be individually accessed on the original image.

19. The apparatus of claim 18, wherein each of the plurality of vector graphic components edited by the editing processing unit comprises relative position information and size information with respect to a resolution of the original image or a screen of the portable display device.

20. An edited image storing apparatus in a portable display device, the apparatus comprising:
a determiner which determines whether an edited image comprises a vector graphic component if an image editing operation has ended; and
a storage unit which stores the vector graphic component based on a result determined by the determiner.

21. The apparatus of claim 20, wherein the storage unit further comprises a selector which selects whether the vector graphic component is stored as a separate file if the determiner determines that the edited image comprises the vector graphic component.

22. The apparatus of claim 21, wherein the storage unit further comprises an extractor which extracts the vector graphic component from the edited image if the selector selects that the vector graphic component is stored as a separate file.

23. The apparatus of claim 22, wherein:
the storage unit stores the vector graphic component as a separate file from the edited image if the selector selects that the vector graphic component is stored as a separate file, or
the storage unit stores the vector graphic component with the edited image as the same file if the selector selects that the vector graphic component is not stored as a separate file.

24. The apparatus of claim 20, wherein the storage unit stores a plurality of vector graphic components to be individually accessible if the determiner determines that the edited image comprises the plurality of vector graphic components.

25. The apparatus of claim 24, wherein the storage unit stores a resolution of an original image of the edited image and position information and size information of the vector graphic component.
